(19) United States
(12) Patent Application Publication
(10) Pub. No.: US 2014/0328984 A1
(43) Pub. Date: Nov. 6, 2014

(54) PROCESS FOR MAKING FORTIFIED OILSEED ANIMAL FEED

(71) Applicant: Raymond D. Legault, St-Albert (CA)

(72) Inventor: Raymond D. Legault, St-Albert (CA)

(73) Assignee: R.D. LEGAULT SEEDS, LTD., St-Albert, ON (CA)

(21) Appl. No.: 14/351,308

(22) PCT Filed: Oct. 12, 2011
(86) PCT No.: PCT/CA2011/001140

§ 371 Date: May 23, 2014

(51) Int. Cl. A23K 1/00

(52) U.S. Cl. CPC A23K 1/001
USPC 426/241; 426/431

(57) ABSTRACT

A process is provided for fortifying oilseeds for consumption by animals, comprising heat treating the oilseeds; steeping the oilseeds at a temperature of about 210° F. to about 300° F.; and treating the oilseeds with a composition while they are at a temperature of about 100° F. to about 230° F. The composition comprises at least one dietary factor and a penetrant. The dietary factor position preferably comprises at least one of an amino acid, a nitrogen source, a vitamin, a mineral, protein and a medicament, and the penetrant preferably comprises a surfactant, such as a saponin.

### FIELD OF THE INVENTION

The present invention relates to a process for making animal feed compositions, and in particular to a process for making oilseed based animal feed compositions fortified with dietary factors.

### BACKGROUND OF THE INVENTION

A large proportion of crops grown worldwide are not intended for human consumption, but rather, are intended for the production of animal feed. On a global basis, soybeans are rapidly accounting for a larger percentage of all crop-based protein sources used in animal feeds, followed by rapeseed (canola) meal, cottonseed meal, sunflower meal, corn meal, and peanut meal. These feeds are routinely fed to various livestock, including ruminants, and are also being utilized as a nutrition source in fish farms.

However, many of these crops, and specifically oilseeds e.g. soybeans, require processing before they can be productively used as a feed. Oilseeds naturally contain compounds that are collectively labeled antinutritional agents, as they tend to have deleterious effects when consumed.

For example, soybeans contain several agents that inhibit trypsin and other proteases. These agents negatively affect many protein-digesting enzymes in the intestinal tract of animals, thereby limiting the breakdown and subsequent absorption of protein. Consequently, animals receiving unprocessed or inadequately processed soybeans exhibit depressed growth. Other undesirable agents include lectins, oligosaccharides, and isoflavones, to name a few. These agents can effectively be destroyed or at least reduced through denaturation with a heat treatment step during processing. When the animal feed is destined for ruminant livestock, an additional goal of processing is to increase the proportion of protein that bypasses the rumen.

Fortification of animal feed is common practice in order to ensure that an animal is meeting all of its nutritional needs. This strategy is not uncommon for monogastric animals, but occurs even more so for ruminants. Ruminants have a multi-compartmental stomach and a complex digestion process. In the early compartments of the stomach, such as the rumen, food is initially broken down into a solid and liquid component. The solid component is typically regurgitated and rechewed to enhance the digestion process. Vast arrays of symbiotic microbes and protozoa also reside in the rumen, which can help to digest and ferment fibrous plants ingested by the animal. The microorganisms also satisfy their own needs, such as the requirement for amino acids, from the food ingested by the animal.

Proteins are made of extended chains of amino acids. Amino acids are classified as essential amino acids (such as lysine and methionine), or non-essential amino acids (such as glycine and alanine), based upon whether the amino acid can be intrinsically produced by the animal. Most animals, including humans, cannot synthesize essential amino acids (or at least not in sufficient quantities), and therefore must obtain these amino acids through their diet. Rumen microorganisms are capable of producing all amino acids (including essential amino acids) by conversion of nitrogen sources, such as protein, urea or ammonia, found in the ruminant's diet. The microorganisms eventually pass along the digestive tract of the ruminant with the other food materials, where they are themselves digested, thereby providing, among other things, a complete array of amino acids to the animal.

However, the microbial population alone cannot support all of a productive ruminant's nutritional needs, especially as it pertains to the essential amino acids. Relatively high protein levels are required in many ruminants, such as cows, as it is necessary for production of e.g.

milk protein, growth, pregnancy and general maintenance. For example, the essential amino acids lysine and methionine have been shown to be often limiting in milk protein production in dairy cows. Therefore, it is often necessary to supplement the diet of the ruminant with e.g. feed protein and amino acids, preferably that which substantially escapes degradation by microorganisms in the rumen, or that which is fortified with elevated levels, so that an adequate amount of the protein and/or amino acids are able to bypass the rumen for eventual digestion and absorption in the small intestine.

In addition, care must be taken when processing oilseeds for animal feed. As noted above, the most common step for preparing oilseeds for animal consumption is the addition of heat. The heat facilitates a chemical reaction that makes certain proteins more resistant to digestion, particularly by ruminant livestock, than normal peptides. However, the heat must be applied to the feed cautiously, as excessive heat causes sugar and amino acid loss, especially of the essential amino acids lysine and methionine, thereby further depleting their availability to the animal.

Strategically, it is often better to supply only the limiting factors to the diet, such as essential amino acids, as opposed to increasing total protein intake. Unused protein is expelled by the animal as nitrogen waste, which is becoming an increasing concern on the environment. Additionally, animal feed can be expensive, so it is important to maximize the efficiency with which protein is used by the animal, in consideration of both the cost of protein in the diet and nitrogen excretion into the environment.

Biofortification, i.e. the fortification of crops while they are still growing through e.g. genetic modification, has been utilized as a method to meet or exceed the nutritional requirements of animals, but the general public is still wary about the use and introduction of genetic engineering in the food chain. However, the supplements themselves, such as protein or amino acids, cannot simply be feed directly to ruminants, as the rumen microorganisms will breakdown the supplements before they reach the stomach and small intestine, thereby decreasing proper absorption. In theory, total feeding could be reduced for ruminants, either by increasing the total levels of the nutritional factors in the feed or by protecting the naturally existing factors within the feed to withstand the degradation that typically occurs in the rumen. There have been many attempts at addressing this issue in the prior art.

U.S. Pat. No. 5,789,001 discloses a ruminally inert fat for supplementation to a ruminant feed, made by applying reducing sugars to oilseed meats and heating to induce non-enzymatic browning. The process is controlled to ensure penetration of the reducing sugars into the interior of cracked oilseed meat prior to browning. The browning reaction renders the protein which surrounds the oil resistant to rumen bacterial degradation to thereby encapsulate the oil in a protective matrix.

U.S. Pat. No. 6,242,013 discloses a method of enhancing the oleic acid content of milk produced by a ruminant, the method includes processing a high oleic material to form a ruminally-protected high oleic material that is resistant to degradation in the rumen of the ruminant, orally feeding the ruminally-protected high oleic material to the ruminant, and milking the ruminant to produce milk. The patent teaches that any conventional technique for ruminally protecting high oleic oilseeds may be employed to obtain ruminally-protected high oleic oilseeds. The patent describes two examples of suitable techniques for ruminally protecting high oleic oilseeds: roasting and non-enzymatic browning.

United States Patent Publication No. 2004/0022928 discloses a process to obtain a feed supplement composition for ruminants comprising the steps: a) cleaning whole raw grains, b) heat treating the whole grains, c) transporting the heat treated whole grains to a vented steeping tank through a flow control system, d) spraying a nitrogenous compound, from a compound tank with a flow control system, into the steeping tank, over the heat treated whole grains, e) crushing the heat treated grains combined with the nitrogenous compound, f) cooling the heat treated and crushed grains in a cooling drum, g) optionally further spraying the nitrogenous compound into the cooling drum, over the heat treated and crushed grains, and h) recovering the feed composition. A feed supplement composition for ruminants, obtained through the above described process, containing: a) at least one variety of raw grains, combined with b) a 5 to 40% nitrogenous compound. The patent teaches that the nitrogenous compound can be urea and/or ammonia, which is added to the soybean material to provide a dietary supplement having nitrogen for additional protein production.

### SUMMARY OF THE INVENTION

According to an aspect of the present invention, there is provided a process for fortifying oilseeds for consumption by animals, comprising the following steps: heat treating the oilseeds; steeping the oilseeds at a temperature of about 210° F. to about 300° F.; treating the oilseeds with a composition while they are at a temperature of about 100° F. to about 230° F.; wherein the composition comprises at least one dietary factor and a penetrant.

In one embodiment of the present invention, the process includes at least one of the following additional steps: flaking the oilseeds after steeping and prior to flaking; preheating the oilseeds to a predetermined temperature prior to heat treating the oilseeds; and cleaning the oilseeds prior to commencing the process.

In another embodiment of the present invention, the penetrant is a surfactant, such as a saponin. Optionally, the penetrant is biodegradable, such as an extract of Yucca schidgera, Yucca elata, Quillaja saponaria and/or Yucca valida.

### BRIEF DESCRIPTION OF THE DRAWINGS

The present invention will now be described in detail having regard to the Drawings in which:

FIG. 1 is a flow chart outlining a process for producing fortified animal feed according to an embodiment of the invention.

### DETAILED DESCRIPTION OF THE INVENTION

A better understanding of the present invention and its objects and advantages will become apparent to those skilled in this art from the following detailed description, wherein there is described only the preferred embodiment of the invention, simply by way of illustration of the best mode contemplated for carrying out the invention. As will be realized, the invention is capable of modifications in various obvious respects, all without departing from the scope and spirit of the invention. Accordingly, the description should be regarded as illustrative in nature and not as restrictive.

The term “about” is used herein to mean approximately. When the term “about” is used in conjunction with a numerical range, it modifies that range by extending the boundaries above and below the numerical values set forth. In general, the term “about” is used herein to modify a numerical value above and below the stated value by a variance of 10%.

The present invention relates to fortified animal feed and the associated fortification process. The animal feed is preferably substantially comprised of oilseeds, such as soybeans, sunflower seed, cottonseed, rapeseed, flaxseed, linseed, peanuts and the like. According to a more preferred embodiment, the animal feed is comprised of soybeans.

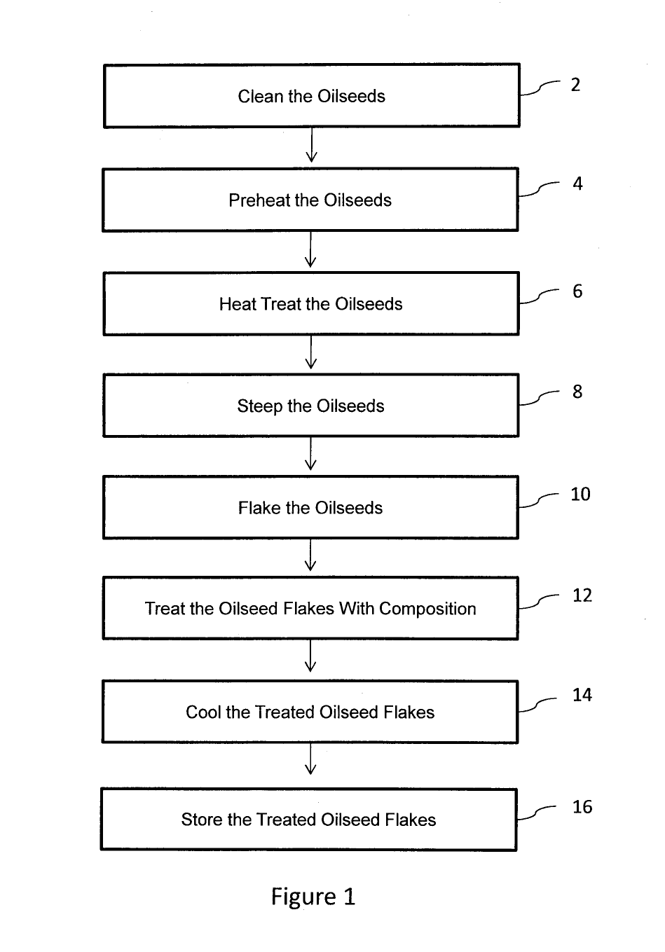

An embodiment of the invention is shown in FIG. 1, where there is illustrated a flow chart outlining an exemplary process for making fortified animal feed. An optional first step 2 in the process involves preparing and cleaning the oilseed. The cleaning step 2 is typically required if the animal feed is particularly soiled, and often includes cleaning any loose debris, such as dirt, dust and stones, removing husks or seed coats from the seeds and separating the seeds from the chaff. On a small-scale, the preparation and cleaning of the raw material can be done manually, such as by winnowing, but typically, this step 2 is handled by machinery that is known in the art.

A second optional step 4 in the process involves preheating the oilseeds prior to the ultimate heat treatment step 6. The preheating step 4 slowly increases the temperature of the oilseeds. The gradual increase in temperature that comprises the heat pretreatment step 4 may be gentler on the integrity of the oilseeds. A preheating step 4 is preferred with respect to the finished product i.e. the animal feed, as the preheating 4 will place the oilseeds at a substantially uniform temperature prior to undergoing further heat treatment 6, thereby accelerating the cooking step and providing a level of homogeneity to the animal feed. In one embodiment, the animal feed is heated to a temperature of between at least about 0° F. to about 100° F. during the heat pretreatment step 4, however, any increase in temperature that preferably normalizes the temperature of the batch of oilseeds prior to heat treatment is contemplated. The heat pretreatment 4 can occur from anywhere from 5 minutes to 30 minutes, or as long as is required to normalize the temperature of the oilseeds at an elevated level prior to the heat treatment 6.

The heat for the heat pretreatment step 4 can be generated through an independent heat source, such as burners, that are primarily purposed for the heat pretreatment step 4. Alternatively, the heat may be derived from heat that is diverted away from that which is generated during the heat treatment step 6.

A heat treatment step 6 is typically required if the goal of the oilseed processing is to produce animal feed, as heat treatment in general, which may include the heat pretreatment step 4, heat treatment 6 and steeping 8, aids in providing a homogeneous product where the antinutritional factors have been reduced to a more desirable level and the bypass protein level of the animal feed is elevated. Therefore, any form of heat treatment 6 that addresses these elements is contemplated within the scope of this process.

Among the various forms of heat treatment, the factors which may vary from one process to another are length of exposure time, temperature, pressure, humidity, exposed surface, oilseed particle size and type of energy used, but ultimately, the heat treatment step primarily uses heat energy to, among other things, inactivate the antinutritional factors. An additional benefit typically achieved with a heat treatment step 6 is an increase in available energy and improved digestibility for the animal, thought to be due to the gelatinisation of starch molecules in the oilseeds. The heat treatment step 6 also reduces the initial moisture of the oilseed.

The mode of the heat treatment step 6, and specifically how the heat is applied to the oilseeds should not be considered limiting, and can be performed by any food stuff heat treatment technique known in the art, and also by any method capable of applying heat to the oilseed. For example, the heat treatment 6 of the oilseeds can be accomplished through roasting, fluidized bed models, cascade roasting, jet-sploding, micronizing and microwave treatments.

In one embodiment, the temperature of the oilseeds reaches at least between about 200° F. and about 300° F. during the heat treatment step 6, although higher temperatures, such as those routinely used during the heat treatment of oilseeds in the art are also contemplated. Preferably, the internal temperature of the oilseeds reaching between at least about 190° F. to about 215° F., but this will vary depending upon such factors as the type of heat treatment 6 that is applied, type of oilseed, moisture content of the oilseed, etc.

Following the heating treatment step 6, the oilseeds are allowed to steep 8, which continues the cooking procedure by using the residual heat of the oilseeds. Steeping is believed to increase protein denaturation, optimize digestibility, reduce the initial moisture content of the oilseed and enhance starch granule production. In one embodiment, the oilseeds are transferred from the heat treatment location to a continuous flow steeping vessel. The oilseeds continuously travel through the steeping vessel until they exit through the bottom portion thereof. The rate of flow of the oilseeds can be altered, as necessary, in order to manipulate the time spent steeping in the vessel.

According to another embodiment, the oilseeds are stationary during steeping 8. For example, after the heat treatment step 6, the oilseeds are transferred to a vat or container, where the oilseeds rest and steep in their own radiant heat.

Steeping times may vary depending upon such factors as the temperature of the oilseeds when they enter the steeping vessel, etc. In one embodiment, the oilseeds are transferred to a continuous flow steeper directly after heat treatment 6, at which point they typically have an external temperature of about 225° F. to about 295° F. Preferably the oilseeds are steeped from 10 to 30 minutes. In such an embodiment, it is preferred that the oilseeds would have an external temperature of about 210° F. to about 230° F. upon leaving the steeping vessel.

Following the heat treatment 6 and steeping 8 of the oilseeds, the oilseeds are optionally flaked or milled 10. Flaking is a common step during the preparation and conditioning of oilseeds, and is thought to rupture seed cellular structure, such as starch granules, reduce moisture in the oilseeds, and potentially further reduce levels of antinutritional factors. Flaking of the oilseeds 10 can be performed by any technique and machinery known in the art, such as by using rollers or a mill to grind the oilseeds. In one embodiment, the oilseeds are flaked 10 essentially immediately after steeping 8 while the oilseeds are still soft and malleable, thereby minimizing cracking and crumbling of the seeds. In a preferred embodiment, the oilseeds are flaked/milled after steeping.

After the heat treatment 6, steeping 8 and optional flaking 10 of the oilseeds, the oilseeds are treated with an aqueous composition 12. The volume of the composition may vary, but preferably, the volume is sufficient to expose a substantial amount of the oilseeds to the composition. In one embodiment, the composition is about 25 gallons for treatment of about 1 tonne of oilseeds. Application of the aqueous composition to the oilseeds may vary. For example, the oilseeds may be immersed and soaked in the aqueous composition. The exposure of the oilseeds to the aqueous composition may be for a relatively short period of time, such as instantaneous immersion, or the oilseeds may be submerged for a longer period of time, such as 10 to 30 minutes. Alternatively, the oilseeds may be sprayed with the composition as they, for example, travel along a conveyor belt.

In one embodiment, treatment of the oilseeds occurs after steeping while the oilseeds are at a temperature of about 100° F. to about 230° F. Preferably, the oilseeds are treated with the aqueous composition soon after flaking/milling, and additionally when the oilseeds are at their highest temperature post flaking/milling. However, it is possible that the oilseeds could be kept warm after steeping, and optionally flaking, by, for example, being placed in an oven, in which case treatment of the oilseeds with the aqueous composition 12 may be delayed.

In one embodiment, the composition comprises a single dietary factor, however, in another embodiment, the composition comprises a plurality of dietary factors.

According to a further embodiment, the composition comprises a penetrant, such as a surfactant. The penetrant is one that is safe for use in animal food compositions. It is postulated that the penetrant, among other things, aids in the absorption of the at least one dietary factor by the oilseeds. In one embodiment, the penetrant is a naturally occurring, biodegradable surfactant.

Examples of the types of biodegradable surfactants suitable for use in this invention include those which are saponins, such as those extracted from plants, e.g. the genus Yucca, or from other natural sources, such as marine animals. Some preferred saponins include those extracted from Yucca schidgera, Yucca elata, Quillaja saponaria and Yucca valida. Of the saponin surfactants used, those which are nonionic are particularly preferred.

The amount of penetrant, such as a biodegradable surfactant, employed in the aqueous composition typically does not exceed 0.175 percent by weight based on total weight of the composition. Preferably, the biodegradable surfactant makes up from about 0.025 percent to about 0.150 percent, and most preferably, from about 0.075 percent to about 0.135 percent by weight of the composition.

The dietary factor may be selected from amino acids or their chemical precursors, such as the proteinogenic amino acids lysine, methionine, leucine, isoleucine, phenylalanine, threonine, tryptophan, valine, alanine, asparagine, aspartic acid, cysteine, glutamic acid, glutamine, glycine, proline, serine, tyrosine, arginine, histidine and any modified versions, analogs and salts thereof, or the non-proteinogenic amino acids, such as citrulline, ornithine, taurine, carnitine, L-Dopa and any modified versions, analogs and salts thereof. Other uncommon amino acids, such as those utilized in the metabolic synthesis of amino acids, are also contemplated.

The dietary factor may also be a nitrogen source, such as urea, nitrate, nitrite, ammonium and ornithine.

The dietary factor may also be a vitamin, such as vitamin A, thiamin, riboflavin, pyridoxine, cyanocobalamin, biotin, or any of the B vitamins, vitamin C, vitamin D, vitamin K, vitamin E, folic acid and other folates, niacin, pantothenic acid and the like.

The dietary factor may also include minerals, such as iron, calcium, magnesium, zinc, iodine, iron, copper, phosphorous, chromium, selenium, molybdenum, and fluoride. Non-limiting examples of minerals also include any salt thereof.

The dietary factor may also include protein ingredients, including protein obtained from meat meal or fish meal, liquid or powdered egg, yeast extract, bacterial extract, whey protein concentrate and the like.

Any medicament ingredients known in the art, such as antibiotics, antihelmintics and the like, may also constitute the dietary factor. Also included would be hormones, synthetic or otherwise, such as growth hormone, insulin and the like.

The composition may also comprise one or more inert ingredients, such as enhancers, colorants, sweeteners, flavorants and the like.

The amount of the at least one dietary factor in the aqueous composition is not limiting, and will vary according to many factors, including the dietary factor in question and the intended use of the animal feed (i.e. what type of animal will consume the feed). The dietary requirements for animals, including ruminants, are well known in the art, and should be taken into consideration. The amount of the dietary factor included in the aqueous composition will also depend upon such factors as: whether the feed is to be used for maintenance of an animal, increased growth of an animal, during pregnancy of an animal, during lactation of an animal, for an animal with increased activity, and also the age of the animal and its specific environment. Whether the animal feed is meant to have an animal meet its dietary requirements, or to supplement the animal with such things as e.g. limiting amino acids, to levels above dietary requirements in order to enhance protein production, will also need to be taken into consideration when calculating the amount of dietary factor included in the composition.

After the oilseeds are treated with the composition 12, they are allowed to cool 14 and are typically eventually stored 16 for later use. In one embodiment, the oilseeds cool 14 on their own accord, at which point the composition is likely absorbed and internalized by the oilseeds. Alternatively, external cooling devices, such as a fan or refrigeration equipment may be utilized.

Optionally, the cooled oilseeds are treated with a fungicide and/or antimicrobial agent in order to minimize contamination by such contaminants as mold, salmonella and the like, during storage thereof. Any fungicides and/or antimicrobial agents known in the art are contemplated within the scope of the present invention.

1. A process for fortifying oilseeds for consumption by animals, comprising the following steps:
a) heat treating the oilseeds;
b) steeping the oilseeds at a temperature of about 210 EF to about 295 EF;
c) treating the oilseeds with an aqueous composition while they are at a temperature of about 100 EF to about 230 EF;
wherein the aqueous composition comprises at least one dietary factor, and a surfactant to facilitate uptake of the at least one dietary factor into the oilseeds.

2. The process according to claim 1, further comprising the following step between steps b) and c):
flaking the oilseeds.

3. The process according to claim 2, wherein the oilseeds are flaked using a mill.

4. The process according to claim 1, wherein the surfactant is a saponin.

5. The process according to claim 1, wherein the surfactant is an extract of Yucca schidigera, Yucca elata, Quillaja saponaria and/or Yucca valida.

6. The process according to claim 1, wherein the surfactant is used at about 0.025 to 0.175 percent by weight of the aqueous composition.

7. The process according to claim 1, wherein the at least one dietary factor is selected from the group consisting o an amino acid. a nitrogen source, a vitamin, a mineral, protein and a medicament.

8. The process according to claim 7, wherein the amino acid is selected from the group consisting of lysine, methionine, leucine, isoleucine, phenylalanine, threonine, tryptophan, valine, alanine, asparagine, aspartic acid, cysteine, glutamic acid, glutamine, glycine, proline, serine, tyrosine, arginine, histidine, carnitine, citrulline, L-Dopa and any modified versions, analogs and salts thereof.

9. The process according to claim 1, wherein the dietary factor is lysine and/or methionine.

10. The process according to claim 7, wherein the mineral is selected from the group consisting of iron, calcium, magnesium, zinc, iodine, iron, copper, phosphorous, chromium, selenium, molybdenum, fluoride and any salt thereof.

11. The process according to claim 7, wherein the nitrogen source is selected from the group consisting of urea, nitrate, nitrite, ammonium, ornithine and any salts thereof.

12. The process according to claim 7, wherein the vitamin is selected from the group consisting of vitamin A, thiamin, riboflavin, pyridoxine, cyanocobalamin, biotin, vitamin B₆, vitamin C, vitamin D, vitamin K, vitamin E, folic acid, niacin and pantothenic acid.

13. The process according to claim 7 wherein the protein is selected from the group consisting of protein obtained from meat meal or fish meal, liquid or powdered egg, yeast extract, bacterial extract and whey protein:

14. The process according to claim 1, further comprising the following step prior to step a):
preheating the oilseeds to a predetermined temperature:

15. The process according to claim 1, further comprising the following step prior to step a):
cleaning the oilseeds.

16. The process according to claim 1, wherein the oilseeds are soybeans.

17. The process according to claim 1, wherein the heat treating of the oilseeds is performed though roasting, fluidized bed models, cascade roasting, jet-sploding, micronizing and/or microwave treatments.

18. A process for fortifying oilseeds for consumption by animals, comprising the following steps:
a) heat treating the oilseeds;
b) steeping the oilseeds at a temperature of about 210 EF to about 295 EF;
c) flaking the oilseeds; and
d) treating the oilseeds with an aqueous composition while they are at a temperature of about 100 EF to about 230 EF;
wherein the aqueous composition comprises at least one dietary factor and a penetrant.

19. (canceled)

20. The process according to claim 18, wherein the penetrant is a surfactant.

21. (canceled)

22. The process according to claim 18, wherein the penetrant is an extract of Yucca schidigera, Yucca elata, Quillaja saponaria and/or Yucca valida.

23. The process according to claim 18, wherein the penetrant is used at about 0.025 to 0.175 percent by weight of the aqueous composition.

24. The process according to claim 18, wherein the at least one dietary factor is selected from the group consisting of an amino acid. a nitrogen source, a vitamin, a mineral protein and a medicament.

25. The process according to claim 24, wherein the amino acid is selected from the group consisting of lysine, methionine, leucine, isoleucine, phenylalanine, threonine, tryptophan, valine, alanine, asparagine, aspartic acid, cysteine, glutamic acid, glutamine, glycine, proline, serine, tyrosine, arginine, histidine, carnitine, citrulline, L-Dopa and any modified versions, analogs and salts thereof.

26. The process according to claim 18, wherein the dietary factor is lysine and/or methionine.

27-30. (canceled)

31. The process according to claim 18, further comprising the following step prior to step a):
preheating the oilseeds to a predetermined temperature.

32. (canceled)

33. The process according to claim 18, wherein the oilseeds are soybeans.

34. The process according to claim 18, wherein the heat treating of the oilseeds is performed though roasting, fluidized bed models, cascade roasting, jet-sploding, micronizing and/or microwave treatments.
